(19) United States
(12) Patent Application Publication
(10) Pub. No.: US 2018/0254441 A1
(43) Pub. Date: Sep. 6, 2018

(54) BATTERY COMPARTMENT FOR CIRCUIT PROTECTION OF IMITATION CANDLE DEVICES

(71) Applicant: Xiaofeng Li, Shenzhen (CN)

(72) Inventor: Xiaofeng Li, Shenzhen (CN)

(21) Appl. No.: 15/451,361

(22) Filed: Mar. 6, 2017

(51) Int. Cl. H01M 2/10; F21S 6/00; F21S 9/02

(52) U.S. Cl. CPC H01M 2/1055; F21S 6/001; F21W 2121/00; H01M 2220/30; F21S 9/02

(57) ABSTRACT

The disclosed embodiments relate to devices and methods for facilitating the operations and usage of electronic candle devices. In one exemplary aspect, a battery compartment for an imitation candle device can be implemented to include a base plate, a casing coupled to the base plate and forming an enclosure for holding a plurality of batteries, at least one metal plate coupled to the casing, and at least one metal spring coupled to the base plate. The casing includes two or more openings. The metal plate includes a protruding section that is accessible via a first opening of the two or more openings of the casing. The metal spring protrudes through a second opening of the two or more openings of the casing. The height of the metal plate is smaller than the thickness of the casing.

### FIELD OF INVENTION

The subject matter of this patent document relates to systems and apparatus for facilitating protection of the circuitry in imitation candle devices that use an imitation flame.

### BACKGROUND

Traditional true flame candles, when lit, provide a pleasant ambience in many homes, hotels, churches, businesses, etc. Traditional candles, however, provide a variety of hazards including risk of fire, damage to surfaces caused by hot wax, and the possible emission of soot. Flameless candles have become increasingly popular alternatives to traditional candles. With no open flame or hot melted wax, flameless candles provide a longer-lasting, safe, and clean alternative.

Such imitation candle devices often include light sources, such as LEDs, and include electronic circuits that control the operation the imitation candle device. The protection of the electronic circuits, therefore, is important to ensure that the imitation candle devices function safely as expected.

### SUMMARY OF CERTAIN EMBODIMENTS

The disclosed embodiments relate to devices and methods for facilitating the operations and usage of electronic candle devices. The disclosed features enable protection of the control circuits of the imitation candle device without introducing changes to the circuitry design.

In one exemplary aspect, a battery compartment for an imitation candle device is disclosed. The battery compartment comprises a base plate electrically coupled to a central control circuit of the imitation candle device; a casing coupled to the base plate forming an enclosure for holding a plurality of batteries, the casing including two or more openings; at least one metal plate coupled between the base plate and the casing, the metal plate including a convex section that is accessible via a first opening of the two or more openings of the casing; and at least one metal spring coupled to the base plate, protruding through a second opening of the two or more openings of the casing, wherein a height of the metal plate is smaller than a thickness of the casing.

In another exemplary aspect, a battery compartment cover for an imitation candle device is disclosed. The battery compartment cover comprises a base; a support structure coupled to the base, wherein the support structure includes: one or more side walls extending from the base, and a top surface connected to the one or more side walls, the top surface including two or more openings; at least one metal plate coupled to the base and situated between the base and the top surface of the support structure, the metal plate including a convex surface that is accessible via a first opening of the two or more openings of the support structure; and at least one metal spring coupled to the base and protruding through a second opening of the two or more openings of the support structure, wherein a height of the metal plate is smaller than a height of the support structure.

### BRIEF DESCRIPTION OF THE DRAWINGS

FIG. 1 illustrates an exemplary imitation candle device.

FIG. 2 illustrates some of the mechanical and electrical components of an exemplary imitation candle device.

FIG. 3A shows a side view of an exemplary battery compartment of an imitation candle device.

FIG. 3B shows a side view of an exemplary battery compartment cover of an imitation candle device.

FIG. 4A shows a schematic diagram of an exemplary battery compartment with batteries inserted correctly into the battery compartment.

FIG. 4B shows a schematic diagram of an exemplary battery compartment with batteries inserted incorrectly into the battery compartment.

FIG. 5 illustrated an exemplary negative side of a battery.

FIG. 6A shows an exemplary opening on the battery compartment casing.

FIG. 6B shows an exemplary opening on the support platform of the battery compartment cover.

FIG. 7 shows another schematic diagram of an exemplary battery compartment with batteries inserted incorrectly into the battery compartment.

### DETAILED DESCRIPTION OF CERTAIN EMBODIMENTS

In this patent document, the word “exemplary” is used to mean serving as an example, instance, or illustration. Any embodiment or design described herein as “exemplary” is not necessarily to be construed as preferred or advantageous over other embodiments or designs. Rather, use of the word exemplary is intended to present concepts in a concrete manner.

Imitation candle devices can simulate a real candle with a flame that resembles a real-life flame with flickering effects using optical, mechanical and electrical components. The imitation candle devices may provide further features and functionalities that enhance the operation of these devices, and in some cases, enable additional features, such as aesthetic and decorative features, that cannot be obtained with real candles.

Currently, with the continuous progress of science and technology, a variety of new technologies have been developed for imitation candle devices. However, attentions are focused on the appearance and the verisimilitude of the lighting effects. It is notable that improvements regarding the internal features of the candle device are also crucial to ensure the successful manufacture of a compact and robust imitation candle device.

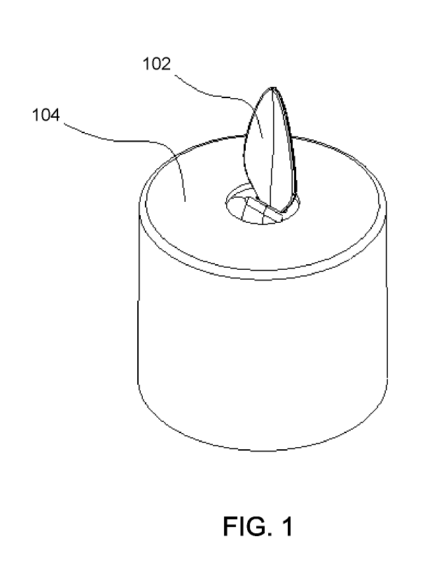

FIG. 1 illustrates an exemplary imitation candle device. The imitation candle device includes a flame element 102 and a shell 104, mimicking the appearance of a real candle. The shell 104 covers internal components of the candle device, which can include one or more light producing devices (not shown) that illuminate the flame element 102 under the control of a central control circuit (not shown). FIG. 1 illustrates one example of an imitation candle device having a flame element 102 that does not move when being illuminated by a light source. Other exemplary imitation candled devices can include a movable flame element. For example, in some implementations, where the flame element is a movable component, the movement of the flame element 102 may also be governed by the control circuit according to a regular pattern, or in accordance with an irregular pattern, depending on the desired visual effects.

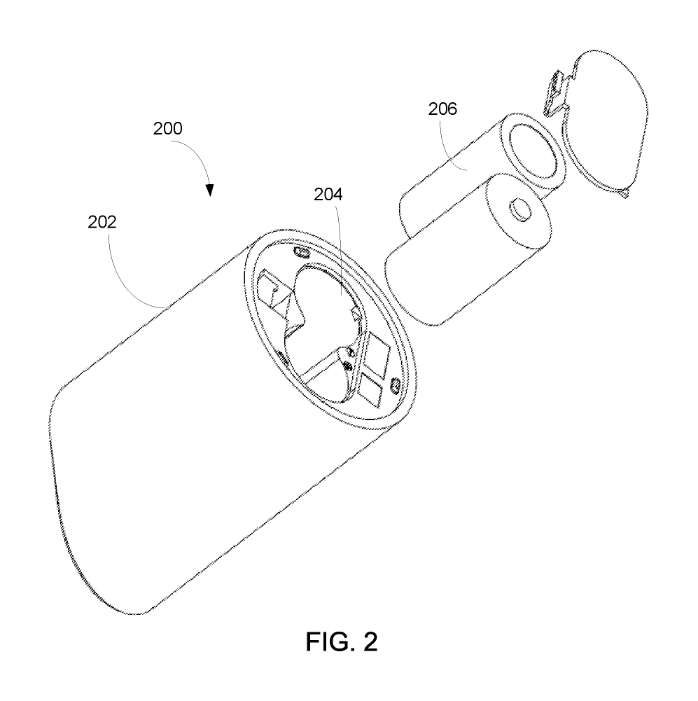

A power supply is required to operate the imitation candle device. FIG. 2 illustrates some of the mechanical and electrical components of an exemplary imitation candle device, including batteries functioning as the power supply. The imitation candle device 200 includes a body 202 and a battery compartment 204 in which power supplies, such as batteries 206, may be installed. When the batteries 206 are correctly inserted into the battery compartment 204, a closed circuitry is formed with the central control circuit, such as a PCB board, to allow the control of the imitation candle device, thereby providing desired function as needed.

However, a user may insert the batteries into the battery compartment incorrectly. As a result, the device would not turn on, which in turn forces the user to reopen the battery compartment to remove and reinsert the batteries in the proper direction. In some instances, the batteries, when incorrectly inserted, can further produce a negative voltage that can cause severe damage to the central control circuit, e.g. the PCB board, and render the imitation candle device unusable. Electric components such as diodes may be used to prevent damages caused by negative voltage. However, the disadvantage of using diodes is that they introduce voltage drops in the circuit, which may not be desirable for the operation of an imitation candle device. The disclosed embodiments relate to a battery compartment configuration that can protect the central control circuit from negative voltage caused by incorrect installation of batteries without introducing any changes to the existing circuitry design.

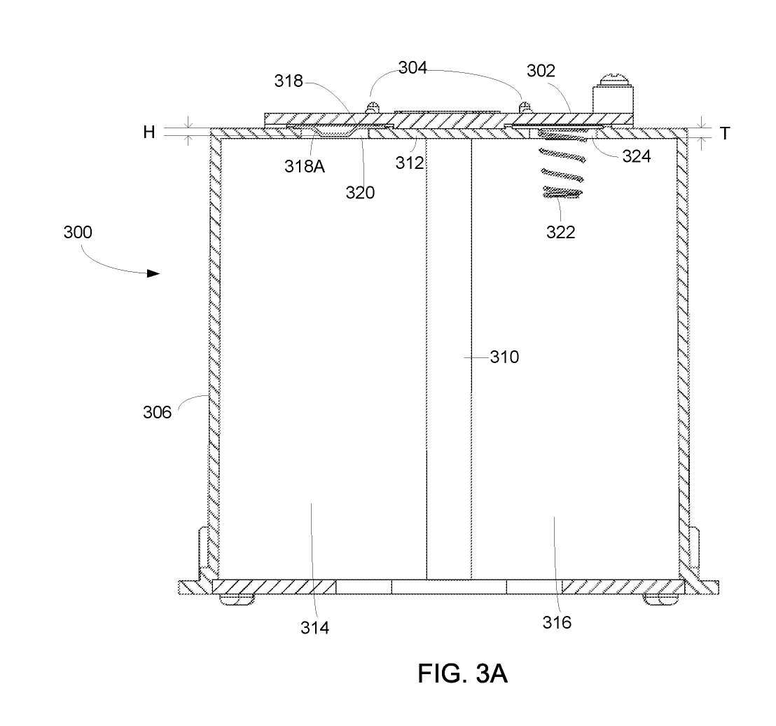

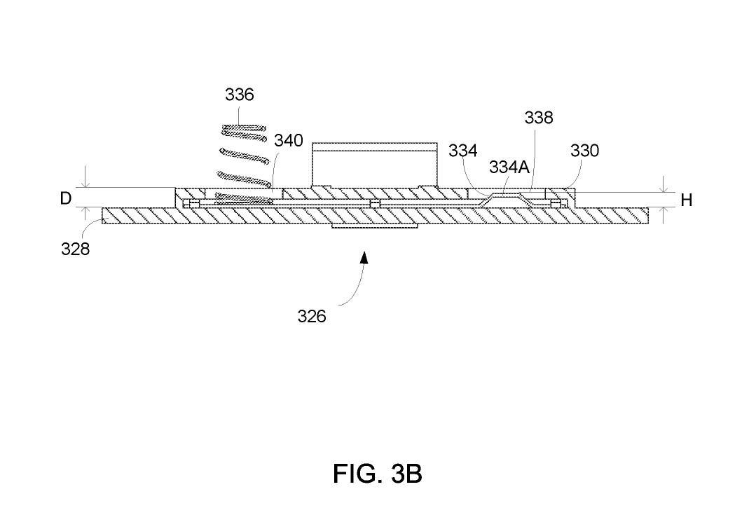

FIG. 3A shows a side view of an exemplary battery compartment of an imitation candle device. The battery compartment 300 includes a base plate 302 that is electrically coupled to the central control circuit (not shown). For example, the central control circuit, e.g. a PCB board, can be positioned on the base plate and electrically coupled to the metal contact points 304 so that the circuit can be supplied with power once the batteries are placed in the battery compartment 300. The battery compartment 300 also includes a casing 306 that encloses the space for placing batteries. The space can be further divided into subsections to hold multiple batteries. In this embodiment, a separator 310 is situated at least partially across the casing 306 to divide the space into two subsections 314, 316 to hold two batteries. Correspondingly, the base section 312 of the casing includes one opening in each of the subsections. In subsection 314, a metal plate 318 is placed between the base plate 302 and the casing 306. The metal plate 318 is shaped, as shown in FIG. 3A, to include a protruding section 318A that is accessible via the opening 320 so that it can be in contact with the positive side of one battery. In particular, the height H of the metal plate 318 is smaller than the thickness T of the base section 312 of the casing. In subsection 316, a metal spring 322 is also placed between the base plate 302 and the casing 306. The metal spring 322 protrudes from the opening 324 to be in contact with the negative side of the other battery.

The battery compartment configuration also includes a battery compartment cover. FIG. 3B shows a side view of an exemplary battery compartment cover of an imitation candle device that can fit into the battery compartment shown in FIG. 3A. In this embodiment, the battery compartment cover 326 corresponds to a battery compartment that holds two batteries. The battery compartment cover 326 includes a base 328 and a support platform 330 that is raised at a distance from the base 328. The support platform 330 creates a hollow space to allow placement of a metal plate 334 and a metal spring 336. The support platform 330 also includes an opening 338 to allow the metal plate 334 to be accessible. The metal plate 334 is shaped, as shown in FIG. 3B, to include a protruding section 334A that is accessible via the opening 338 so that it can be in contact with the positive side of one battery. In particular, the height H of the metal plate 334 is smaller than the height of the support platform 330, which is the distance D between the top surface of the support platform 330 and the top surface of the base 328. An opening 340 allows the metal spring 336 to protrude through the opening 340 to be in contact with the negative side of the other battery.

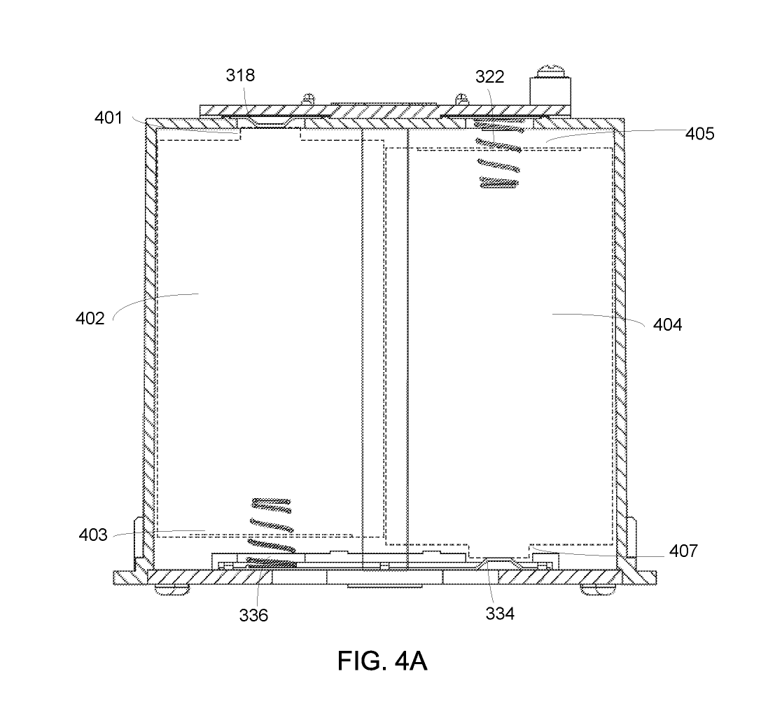

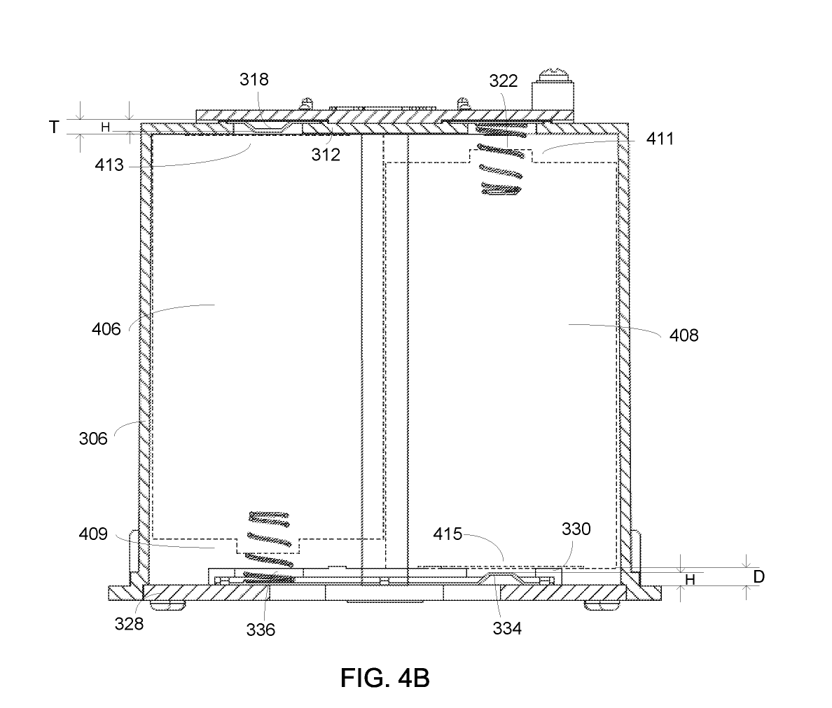

FIG. 4A shows a schematic diagram of the battery compartment with batteries inserted correctly into the battery compartment. In this example, the positive side 401 of battery 402 is in contact with the metal plate 318, and the negative side 403 of battery 402 is in contact with the metal spring 336. Similarly, the positive side 407 of battery 404 is in contact with the metal plate 334, and the negative side 405 of battery 404 is in contact with the metal spring 322. Together, the two batteries 402, 404 and other electrical components of the battery compartment form a closed circuit to provide a positive voltage to the central control circuit.

FIG. 4B shows a schematic diagram of the battery compartment with batteries inserted incorrectly into the battery compartment. In this example, the positive side 409 of battery 406 is in contact with the metal spring 336. Similarly, the positive side 411 of battery 408 is in contact with the metal spring 322. However, because the height H of the metal plate 318 is smaller than the thickness T of the compartment casing 306, the negative side 413 of the battery 406 is only in contact with the base section 312 of compartment casing 306 and not in contact with the metal plate 318. Similarly, because the height H of the metal plate 334 is smaller than height of the support platform (i.e. the distance D between the top surface of the support platform 330 and the top surface of the base 328), the negative side 415 of the battery 408 is only in contact with the support platform 330 of the compartment cover and not in contact with the metal plate 334. Therefore, no close circuit can be formed to damage the central control circuit.

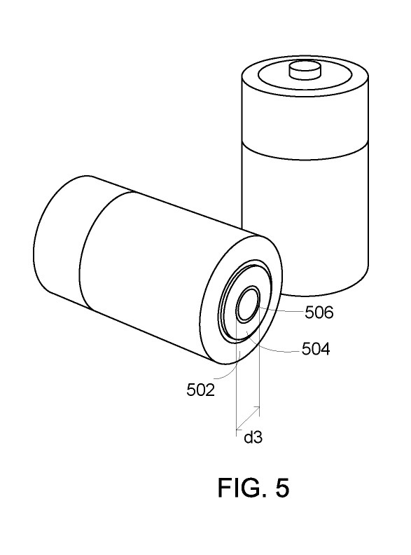

Often times, a battery does not have a flat surface at its negative side. FIG. 5 illustrated an exemplary negative side of a C-sized or D-sized battery. The standard C-sized batteries have a diameter of 26.2 mm and a height of 50 mm, and the standard D-size batteries have a diameter of 34.2 mm and a height of 61.5 mm. The negative side of these batteries usually includes a ring-shaped base surface 502 and a raised surface 504 as the contact point for the negative side. The diameter of the raised surface 504 typically ranges from 15 to 20 mm. The raised surface 504 may optionally include a round groove 506 to further partition the contact point. If the opening 320 at the base section 312 of the casing is too large, the raised surface 504 can fit through the opening 320 to form a close circuit when the battery is inserted incorrectly. Similarly, if the opening 338 at the support platform 330 on the compartment cover 326 is too large, the raised surface 504 can also fit through the opening 338 and form a close circuit to damage the central control circuit.

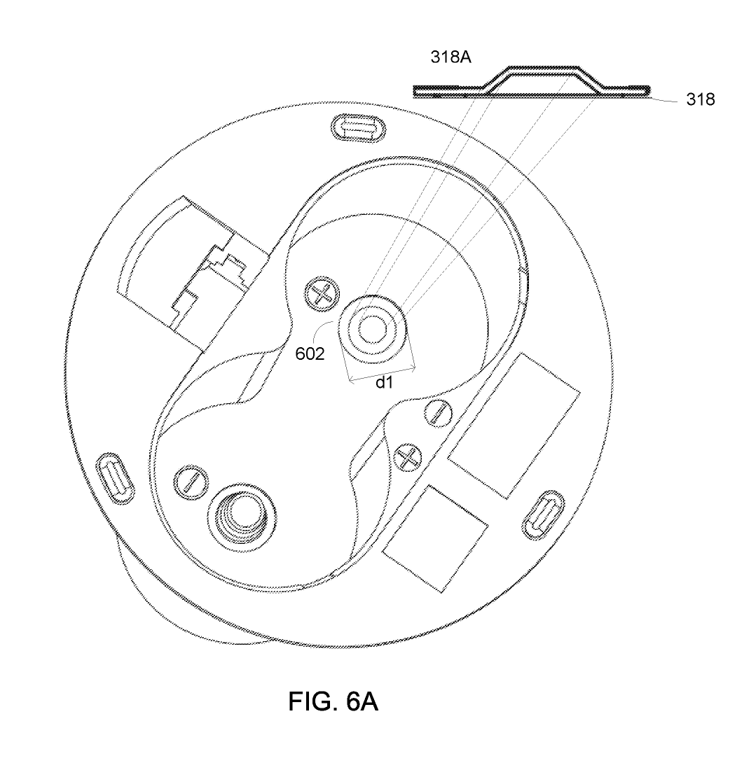

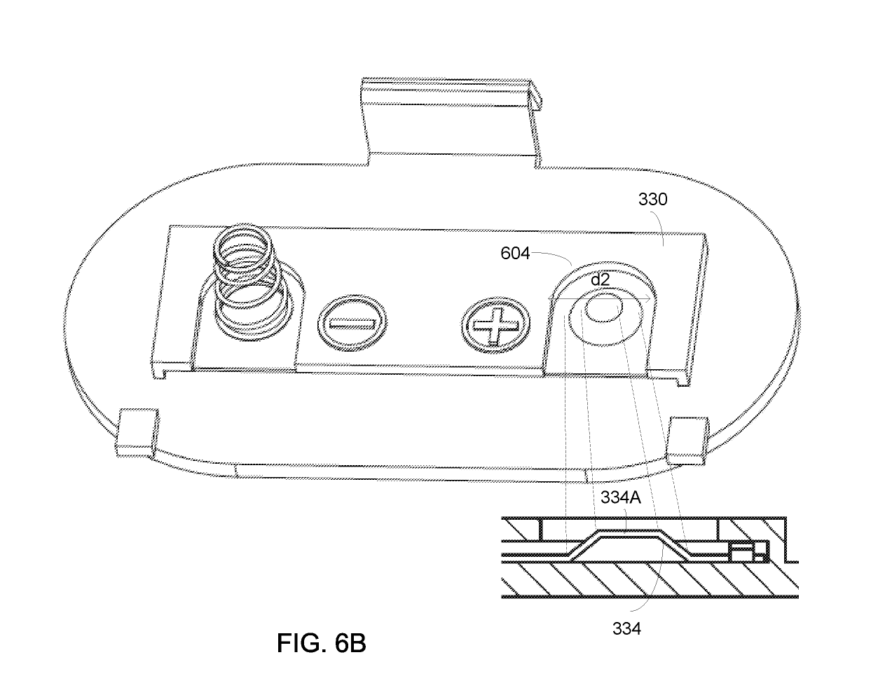

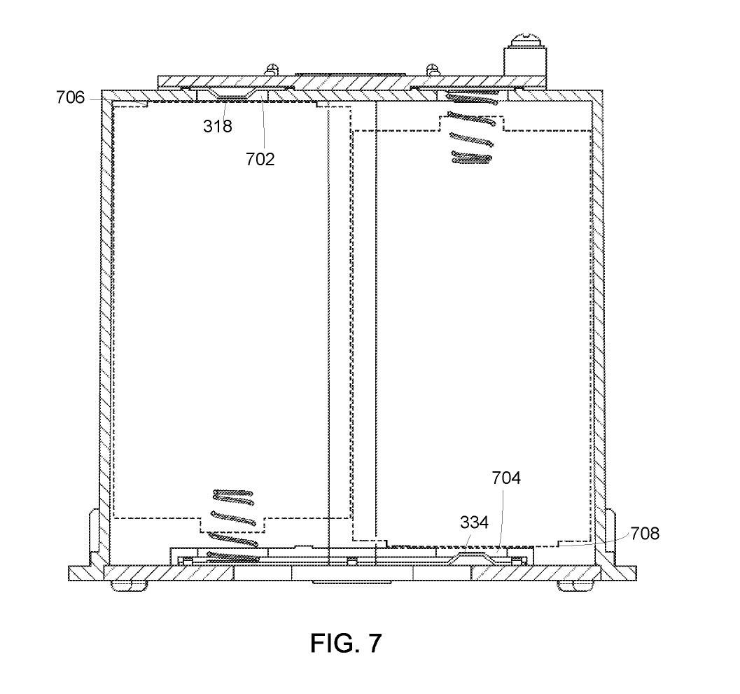

Therefore, it is desirable to have openings smaller than the raised surface 504 at the negative side of the batteries to avoid accidental contact of the metal plates when the batteries are installed incorrectly. FIG. 6A shows an exemplary bottom view of an imitation candle device that includes an opening in the base section of the battery compartment casing. The opening 602 has a diameter d1 that is substantially smaller than the diameter of the raised surface in typical standardized C or D batteries (e.g. around 15-20 mm) but diameter d1 is larger than diameter d3, which is the diameter of the raised positive contact of the C- or D-sized batteries as shown in FIG. 5. The metal plate 318 is accessible via the opening 602 and the protruding section 318A of the metal plate 318 is contained within the walls of the casing. FIG. 6B shows an exemplary opening 604 at the support platform 330 on the compartment cover. The diameter d2 of the opening 604 is also substantially smaller than the diameter of the raised surface in typical standardized C or D batteries (e.g. around 15-20 mm) but diameter d1 is larger than diameter d3, which is the diameter of the raised positive contact of the C- or D-sized batteries as shown in FIG. 5. The metal plate 334 is accessible via the opening 604 and the protruding section 334A of the metal plate 318 is contained within the support structure. As illustrated in FIG. 7, the smaller diameter of the openings 702,704 ensure that the contact points of negative sides of the batteries 706,708 do not come in contact with the metal plates 318, 334 when the batteries are placed incorrectly in the battery compartment.

It should be noted that in the exemplary illustrations described above reference has been made to a base plate (e.g., base plate 318 in FIG. 3A and base plate 334 in FIG. 3B). It is however understood that such a base plate can be replaced by an element that is shaped to include a protruding section or a raised platform. For example, such an element can be a solid metal structure having a thicker central section and a thinner peripheral section, where the thicker central portion includes inclined sidewalls that extend toward the thinner peripheral section. It should also be noted that while some of the above exemplary embodiments have been described as including two C- or D-sized batteries, in other embodiments, configurations with more than two batteries and/or with other types of batteries can be implemented in conformance with the disclosed technology.

It is thus evident that, in one aspect of the disclosed technology, a battery compartment for an imitation candle device can be implemented to include a base plate, a casing coupled to the base plate for holding a plurality of batteries, at least one metal plate coupled between the base plate and the casing, and at least one metal spring coupled to the base plate. The base plate is electrically coupled to a central control circuit of the imitation candle device. The casing includes two or more openings. The metal plate includes a convex section that is accessible via a first opening of the two or more openings of the casing. The metal spring protrudes through a second opening of the two or more openings of the casing. The height of the metal plate is smaller than the thickness of the casing. In some embodiments, the diameter of the first opening is substantially smaller than a diameter of a standard C battery. In some other embodiments, the diameter of the first opening is substantially smaller than a diameter of a standard D battery. For example, the diameter can be around 10 mm.

In another aspect of the disclosed technology, a battery compartment cover for an imitation candle device can be implemented to include a base, a support structure coupled to the base, at least one metal plate, and at least one metal spring. The support structure includes one or more side walls extending from the base, and a top surface connected to the one or more side walls. The top surface includes two or more openings. The metal plate is coupled to the base and is situated between the base and the top surface of the support structure. The metal plate includes a convex surface that is accessible via a first opening of the two or more openings of the support structure. The metal spring is coupled to the base and protrudes through a second opening of the two or more openings of the support structure. The height of the metal plate is smaller than the height of the support structure. In some embodiments, the diameter of the first opening is substantially smaller than a diameter of a standard C battery. In some other embodiments, the diameter of the first opening is substantially smaller than a diameter of a standard D battery. For example, the diameter can be around 10 mm.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed are:

1. A battery compartment for an imitation candle device, comprising:
a base plate electrically coupled to a central control circuit of the imitation candle device;
a casing, coupled to the base plate and forming an enclosure for holding a plurality of batteries, the casing including two or more openings, each opening shaped to accommodate one end of one of the plurality of batteries;
at least one metal plate coupled to the casing, the metal plate including a protruding section that is accessible via a first opening of the two or more openings of the casing to accommodate an electrically positive end of a first battery of the plurality of batteries; and
at least one metal spring coupled to the base plate and protruding through a second opening of the two or more openings of the casing to accommodate an electrically negative end of a second battery of the plurality of batteries,
wherein a height of the protruding section of the metal plate is smaller than a thickness of a section of the casing that surrounds the first opening to prevent contact of an electrically negative end of the first battery with the protruding section of the metal plate.

2. The battery compartment of claim 1, wherein a diameter of the first opening is substantially smaller than a diameter of a standard C-sized battery.

3. The battery compartment of claim 1, wherein a diameter of the first opening is substantially smaller than a diameter of a standard D-sized battery.

4. The battery compartment of claim 1, wherein a diameter of the first opening is around 10 mm.

5. The battery compartment of claim 1, wherein a diameter of the protruding section of the metal plate is around 3 mm.

6. The battery compartment of claim 1, wherein the first opening has a circular shape.

7. The battery compartment of claim 1, wherein the protruding section of the metal plate has a circular shape.

8. The battery compartment of claim 1, wherein the protruding section is contained within walls of the casing.

9. A battery compartment cover for an imitation candle device, comprising:
a base;
a support structure coupled to the base, wherein the support structure includes:
one or more side walls extending from the base, and
a top surface connected to the one or more side walls, the top surface including two or more openings, each opening shaped to accommodate one end of one of the plurality of batteries;
at least one metal plate coupled to the base, the metal plate including a protruding section that is accessible via a first opening of the two or more openings of the support structure to accommodate an electrically positive end of a first battery of the plurality of batteries; and
at least one metal spring coupled to the base and protruding through a second opening of the two or more openings of the support structure to accommodate an electrically negative end of a second battery of the plurality of batteries,
wherein a height of the protruding section of the metal plate is smaller than a height of the support structure that surrounds the first opening to prevent contact of an electrically negative end of the first battery with the protruding section of the metal plate.

10. The battery compartment cover of claim 9, wherein a diameter of the first opening is substantially smaller than a diameter of a standard C battery.

11. The battery compartment cover of claim 9, wherein a diameter of the first opening is substantially smaller than a diameter of a standard D battery.

12. The battery compartment cover of claim 9, wherein a diameter of the first opening is around 10 mm.

13. The battery compartment cover of claim 9, wherein a diameter of the protruding section of the metal plate is around 3 mm.

14. The battery compartment cover of claim 9, wherein the first opening has a circular shape.

15. The battery compartment cover of claim 9, wherein the protruding section of the metal plate has a circular shape.

16. The battery compartment cover of claim 9, wherein the protruding section is contained within the top surface and the one or more side walls of the support structure.
